(19) United States
(12) Patent Application Publication
(10) Pub. No.: US 2012/0312803 A1
(43) Pub. Date: Dec. 13, 2012

(54) INDUCTION HOB AND A METHOD FOR CONTROLLING AN INDUCTION HOB

(75) Inventors: Laurent Jeanneteau, Compiegne (FR); Thibaut Rigolle, Forli (IT); Massimo Zangoli, Santarcangelo di Romagna (IT); Svend Erik Christiansen, Faenza (IT)

(73) Assignee: ELECTROLUX HOME PRODUCTS CORPORATION N.V., Brussel (BE)

(21) Appl. No.: 13/496,273

(22) PCT Filed: Nov. 25, 2010
(86) PCT No.: PCT/EP10/07145

§ 371 Date: Aug. 27, 2012

(30) Foreign Application Priority Data
Nov. 27, 2009 (EP) 09014767.9

(51) Int. Cl. H05B 6/06; H05B 6/12

(52) U.S. Cl. 219/622

(57) ABSTRACT

The present invention relates to an induction hob with a cooking surface (10) and a number of induction coils (12; 16, 18) within said cooking surface (10). The induction coils (12; 16, 18) are arranged on the cooking surface (10) according to predetermined scheme, so that at least two induction coils (12; 16, 18) can be covered by a standard cooking vessel (14). Each induction coil (12; 16, 18) is connected to at least one induction generator being switched or switchable between a high power and a low power. Each induction generator is separately controllable, so that the induction coils (12; 16, 18) are switched or switchable between the high power and the low power. At least one control unit is provided for controlling the individual induction coils (12; 16, 18) according to a predetermined time pattern. Further, the present invention relates to a corresponding method for controlling the induction hob.

The present invention relates to an induction hob with a cooking surface and a number of induction coils within said cooking surface. In particular, present invention relates to an induction hob for household appliances. Further, the present invention relates to a method for controlling an induction hob with a cooking surface and a number of induction coils within said cooking surface.

Induction hobs, in particular for household appliances, become more and more popular. The inductions hob comprises a number of inductions coils arranged on a cooking surface. There are different arrangements for the cooking zones and the induction coils. The cooking surface may include one-size zones, multi-size zones and/or joined zones. It is requested by users that a cooking vessel may be located at different locations of the cooking surface.

In a typical induction hob one cooking zone may comprise one or two induction coils. If one cooking vessel covers one cooking zone, then the power is controlled by varying the frequency of an induction generator. For example, the power may be set at a value between 0 W and 4000 W.

If two cooking vessels cover two inductions coils, wherein one cooking vessel covers one induction coil in each case, then the control system regulates each induction coil and uses a power sharing, since two induction coils cannot run with full power at the same time. If one cooking vessel covers two inductions coils, then the control system regulates each induction coil and uses the power sharing, wherein the same power for each induction coil is provided.

It is an object of the present invention to provide an induction hob and a method for controlling an induction hob, which allow a simplified control of the inductions coils.

The object of the present invention is achieved by the induction hob according to claim 1.

According to the present the induction hob includes a cooking surface and a number of induction coils within said cooking surface, wherein:
the induction coils are arranged on the cooking surface according to predetermined scheme, so that at least two induction coils can be covered by a standard cooking vessel,
each induction coil is connected to at least one induction generator being switched or switchable between a high power and a low power,
each induction generator is separately controllable, so that the induction coils are switched or switchable between the high power and the low power, and
at least one control unit is provided for controlling the individual induction coils according to a predetermined time pattern.

The core idea of the present invention is that each single induction coil work at two fixed powers on the one hand and at least two inductions coils can be covered by a standard cooking vessel on the other hand. The power received by the cooking vessel is controlled by switching on and off the individual inductions coils below said cooking vessel. A continuous power spectrum for the single induction coil is not provided and not necessary.

According to a preferred embodiment of the present invention the power of the induction generator corresponds with a frequency, so that the selection of the frequency of the induction generator determines the power of the corresponding induction coil.

In particular, two fix frequencies are provided for each induction generator.

Preferably, the induction coils on the cooking surface have the same sizes. This contributes to a production with low costs.

For example, the induction coils on the cooking surface are arranged in the form of a rectangular matrix.

Alternatively, the induction coils on the cooking surface are arranged in the form of a honeycomb. The honeycomb form allows a dense arrangement of induction coils on the cooking surface.

Preferably, the low power is between 10% and 20% of the high power.

The object of the present invention is also achieved by the method according to claim 8.

The method for controlling an induction hob according to the present invention is provided for an induction hob with a cooking surface and a number of induction coils with such sizes, that at least two induction coils can be covered by a standard cooking vessel, wherein each induction coil, which is completely or partially covered by the cooking vessel, is individually switched between a high power and a low power according to a predetermined time pattern by controlling induction generators, and each induction coil corresponds with at least one induction generator.

The main idea of the method according to the present invention is that each single induction coil is activated at two fixed powers on the one hand and at least two inductions coils are covered by a standard cooking vessel on the other hand. The power received by the cooking vessel is controlled by switching on and off the individual inductions coils below said cooking vessel.

In particular, the selection of a frequency of the induction generator determines the power of the corresponding induction coil.

Preferably, two fix frequencies are provided for each induction generator.

According to a preferred embodiment of the present invention the low power is between 10% and 20% of the high power.

Novel and inventive features of the present invention are set forth in the appended claims.

The present invention will be described in further detail with reference to the drawings, in which

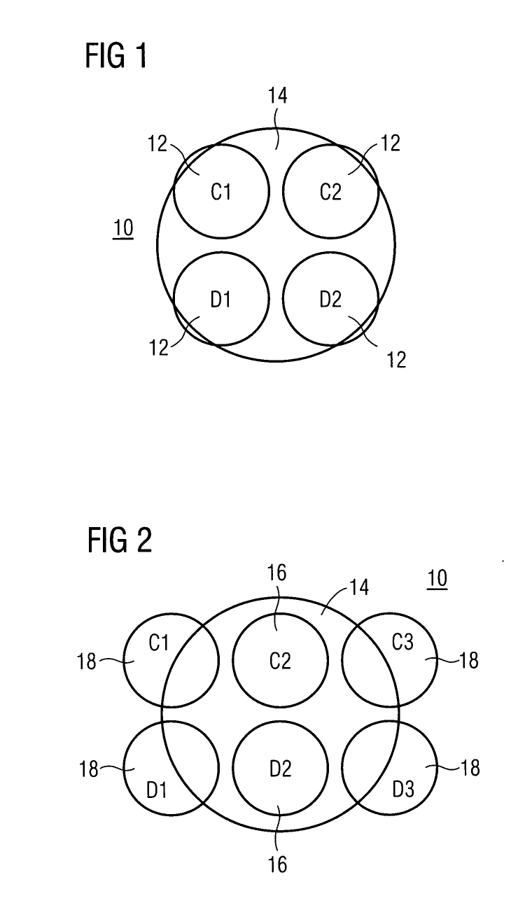

FIG. 1 illustrates a schematic top view of an arrangement of four inductions coils within a cooking surface of an induction hob according to a first embodiment of the present invention, and

FIG. 2 illustrates a schematic top view of an arrangement of six inductions coils within the cooking surface of the induction hob according to a second embodiment of the present invention.

FIG. 1 illustrates a schematic top view of an arrangement of four inductions coils 12 within a cooking surface 10 of an induction hob according to a first embodiment of the present invention. In this example, each induction coil has either a fixed power of 500 W or two possible powers of 500 W and 80 W.

The four inductions coils 12 are arranged on the cooking surface 10. Said inductions coils 12 form a square. A cooking vessel 14 with a circular bottom side is put on the cooking surface 10. The cooking vessel 14 covers all four inductions coils 12 completely. In this example, the cooking vessel 14 may receive a maximum power of 2000 W, since each of the induction coils has a power of 500 W.

The power provided for the cooking vessel 14 may be controlled by creating a rotating effect. During said rotating effect the induction coils 12 are alternating activated and deactivated. Said rotating effects avoid that some of the induction coils 12 are continuously activated and the remaining induction coils 12 are deactivated the whole time.

If the user requires a power of 1500 W, then three of the four induction coils 12 are activated simultaneously.

The cooking process is timely subdivided into a plurality of identical cooking cycles. In this embodiment each cooking cycle comprises four time intervals.

The following table shows an example of a cooking cycle with a power of 1500 W. The four induction coils are denoted as C1, C2, D1 and D2, respectively, wherein the letters represent the lines and the numbers represent the columns of the induction coils on the cooking surface.

| | 1^{st} interval | 2^{nd} interval | 3^{rd} interval | 4th interval |
|---|---|---|---|---|
| C1 | X | | X | X |
| C2 | X | X | | X |
| D1 | X | X | X | |
| D2 | | X | X | X |

During a first interval the inductions coils C1, C2 and D1 are activated and the induction coil D2 is deactivated. In a second interval the inductions coils C2, D1 and D2 are activated and the induction coil C1 is deactivated. In a following third interval the inductions coils C1, D1 and D2 are activated and the induction coil C2 is deactivated. During a last fourth interval the inductions coils C1, C2 and D2 are activated and the induction coil D1 is deactivated.

Please note, if the each induction coil 12 has the fixed power of 500 W, then the deactivated induction coils 12 run with the power of 0 W in each case. However, if the each induction coil 12 has the two possible powers of 500 W and 80 W, then the “deactivated” induction coils 12 run with the power of 80 W in each case.

In a similar way, if a power of 1000 W is requested by the user, then only two induction coils 12 are activated in the same interval. The remaining induction coils 12 are deactivated and run with the power of 80 W or 0 W, respectively.

Further, if a power of 1250 W is requested by the user, then two induction coils 12 are activated during two intervals and three induction coils 12 are activated during the other two intervals. Preferably, the intervals with two and three activated inductions coils 12 are alternating.

In general, each induction coil 12 can operate with two fixed power values. Power values other than said fixed values are not provided. This allows induction generators with less complexity. In this example each induction coil 12 is connected to at least one induction generator. The induction generators are not shown. The induction generators are controlled by a control unit, which is also not shown. The power of the induction coil 12 is set by a corresponding frequency of the induction generator. For example, a high power for the induction coil 12 corresponds with a frequency of about 20 kHz and a low power for the induction coil 12 corresponds with a frequency of about 40 kHz.

FIG. 2 illustrates a schematic top view of an arrangement of six induction coils 16 and 18 within the cooking surface 10 of the induction hob according to a second embodiment of the present invention. This embodiment is advantageous, if a relative low power is requested by the user and the cooking vessel 14 covers several induction coils 16 and 18. Each induction coil 16 and 18 is connected to at least one induction generator controlled by the control unit. The induction generators and the control unit are not shown.

The six induction coils 16 and 18 are arranged by three columns and two lines on the cooking surface 10. The induction coils 16 and 18 are denoted as C1, C2, C3, D1, D2 and D3, respectively, wherein the lines are represented by the letters and the columns are represented by the numbers. The two induction coils of the second column are defined as central induction coils 16. The four induction coils of the first and third columns are defined as lateral induction coils 18. The cooking vessel 14 covers the central induction coils 16 completely and the lateral induction coils 18 only partially.

Since the lateral induction coils 18 are not covered completely, it is convenient that the central induction coils 16 are activated with a high power and the lateral induction coils 16 are activated with a low power.

The two fixed powers of each induction coil 12, 16 and 18 allow an induction generator with low complexity. Since the inductions coils 12, 16 and 18 have such a size, that the cooking vessel 14 covers at least two inductions coils 12 and 16, the number of possible power values increases with the number of inductions coils 12, 16 and 18 covered by the cooking vessel 14.

A power sharing can be realized for the inductions coils 12, 16 and 18 covered by the cooking vessel 14. During said power sharing the power under the cooking vessel 14 depends on the location as well as on time. The induction generators may be switched on and off within a very short time interval, so that a quasi-continuous spectrum of the whole power of the inductions coils 12, 16 and 18 covered by the cooking vessel 14 may be realized.

Although illustrative embodiments of the present invention have been described herein with reference to the accompanied drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 cooking surface
12 induction coil
14 cooking vessel
16 central induction coil
18 lateral induction coil
C1 number of an induction coil
C2 number of an induction coil
C3 number of an induction coil
D1 number of an induction coil
D2 number of an induction coil
D3 number of an induction coil

1. An induction hob with a cooking surface (10) and a number of induction coils (12; 16, 18) within said cooking surface (10), wherein:
the induction coils (12; 16, 18) are arranged on the cooking surface (10) according to predetermined scheme, so that at least two induction coils (12; 16, 18) can be covered by a standard cooking vessel (14),
each induction coil (12; 16, 18) is connected to at least one induction generator being switched or switchable between a high power and a low power,
each induction generator is separately controllable, so that the induction coils (12; 16, 18) are switched or switchable between the high power and the low power, and at least one control unit is provided for controlling the individual induction coils (12; 16, 18) according to a predetermined time pattern.

2. The induction hob according to claim 1, characterized in, that the power of the induction generator corresponds with a frequency, so that the selection of the frequency of the induction generator determines the power of the corresponding induction coil (12; 16, 18).

3. The induction hob according to claim 1, characterized in, that two fix frequencies are provided for each induction generator.

4. The induction hob according to claim 1, characterized in, that the induction coils (12; 16, 18) on the cooking surface (10) have the same sizes.

5. The induction hob according to claim 1, characterized in, that the induction coils (12; 16, 18) on the cooking surface (10) are arranged in the form of a rectangular matrix.

6. The induction hob according to claim 1, characterized in, that the induction coils (12; 16, 18) on the cooking surface (10) are arranged in the form of a honeycomb.

7. The induction hob according to claim 1, characterized in, that the low power is between 10% and 20% of the high power.

8. A method for controlling an induction hob including a cooking surface (10) and a number of induction coils (12; 16, 18) with such sizes, that at least two induction coils (12; 16, 18) can be covered by a standard cooking vessel (14), wherein
each induction coil (12; 16, 18), which is completely or partially covered by the cooking vessel (14), is individually switched between a high power and a low power according to a predetermined time pattern by controlling induction generators, and
each induction coil (12; 16, 18) corresponds with at least one induction generator.

9. The method according to claim 8, characterized in, that the selection of a frequency of the induction generator determines the power of the corresponding induction coil (12; 16, 18).

10. The method according to claim 8, characterized in, that two fix frequencies are provided for each induction generator.

11. The method according to claim 8, characterized in, that the low power is between 10% and 20% of the high power.
